(19) United States
(12) Patent Application Publication
(10) Pub. No.: US 2025/0313664 A1
(43) Pub. Date: Oct. 9, 2025

(54) SILOXANE-MODIFIED POLYESTER RESIN AND CURED PRODUCT THEREOF

(71) Applicant: Shin-Etsu Chemical Co., Ltd., Tokyo (JP)

(72) Inventor: Hitoshi Maruyama, Annaka-shi (JP)

(73) Assignee: Shin-Etsu Chemical Co., Ltd., Tokyo (JP)

(21) Appl. No.: 19/092,199

(22) Filed: Mar. 27, 2025

(30) Foreign Application Priority Data
Apr. 3, 2024 (JP) 2024-060307

(51) Int. Cl. C08G 63/547; C08G 63/553; C08G 63/676

(52) U.S. Cl. CPC C08G 63/547; C08G 63/553; C08G 63/676; C08G 2150/00

(57) ABSTRACT

A siloxane-modified polyester resin having a carboxyl group and a (meth)acryloyl group in a side chain thereof. The siloxane-modified polyester resin is capable of imparting sufficient flexibility to a cured product thereof in addition to heat resistance. The siloxane-modified polyester resin having the carboxyl group and the (meth)acryloyl group in a side chain thereof can provide a cured product having high heat resistance and flexibility.

### CROSS-REFERENCE TO RELATED APPLICATIONS

This non-provisional application claims priority under 35 U.S.C. § 119(a) on Patent Application No. 2024-060307 filed in Japan on Apr. 3, 2024, the entire contents of which are hereby incorporated by reference.

### TECHNICAL FIELD

The present invention relates to a siloxane-modified polyester resin and a cured product thereof.

### BACKGROUND ART

It is known that a siloxane-modified polyimide resin provides a cured product having not only excellent heat resistance but also flexibility, and is suitable for a protective insulating film for a semiconductor element, an insulating film for a multilayer printed substrate, a solder protective film, a cover lay film, and the like (Patent Document 1).

However, in recent years, a flexible device, for example, for medical applications, has been actively developed, and flexibility of a cured product has not yet been achieved in adaptation of such a device, and further improvement has been required.

### CITATION LIST

Patent Document 1: JP-A 2007-217490

### SUMMARY OF THE INVENTION

The present invention has been made in view of the above circumstances, and an object thereof is to provide a siloxane-modified polyester resin capable of imparting sufficient flexibility to a cured product thereof in addition to heat resistance.

As a result of repeated studies to achieve the above object, the present inventor has found that a siloxane-modified polyester resin having a carboxyl group and a (meth)acryloyl group in a side chain thereof provides a cured product having high heat resistance and flexibility, and has completed the present invention.

That is, the present invention provides the following siloxane-modified polyester resin and a thermally cured product thereof.
1. A siloxane-modified polyester resin having a carboxyl group and a (meth)acryloyl group in a side chain thereof.
2. The siloxane-modified polyester resin according to the item 1, which is represented by the following formula (1):

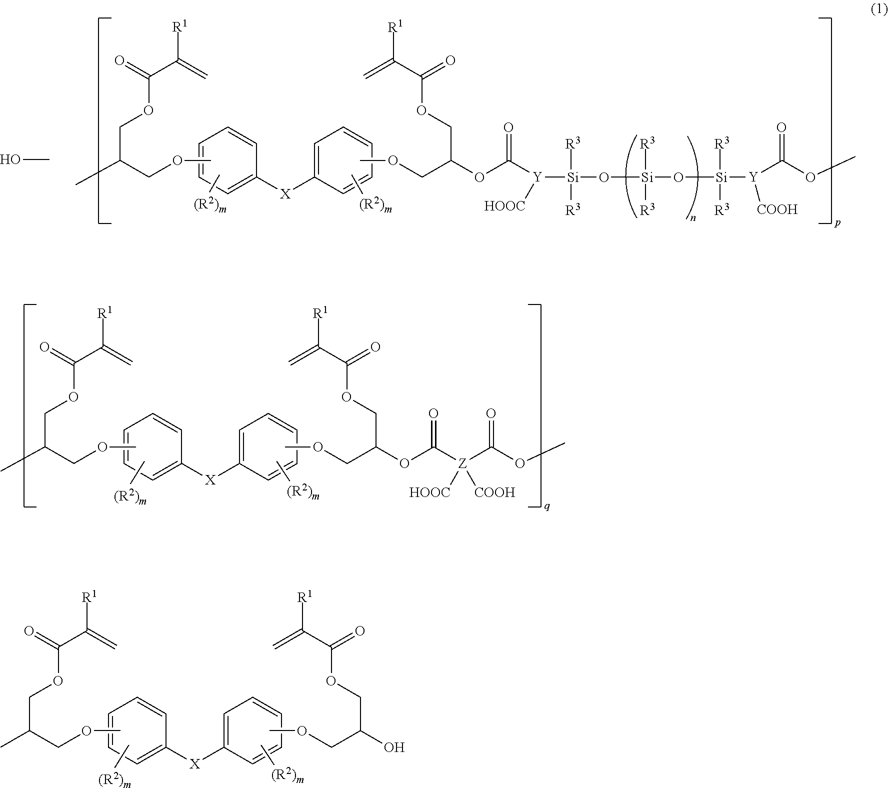

wherein R¹'s each independently represent a hydrogen atom or a methyl group,
R²'s each independently represent an alkyl group having 1 to 5 carbon atoms, an aryl group having 6 to 12 carbon atoms, or a halogen atom,
R³'s each independently represent a hydrocarbyl having 1 to 8 carbon atoms, X's each independently represent a single bond or a divalent organic group,
Y's each independently represent a trivalent organic group,
Z represents a tetravalent organic group,
m's are each independently an integer of 0 to 4, n is a number having an average of 0 to 100, p is an integer of 1 to 30, and q is an integer of 0 to 30.
3. The siloxane-modified polyester resin according to the item 2, wherein Y is a group represented by any one of the following formulas:

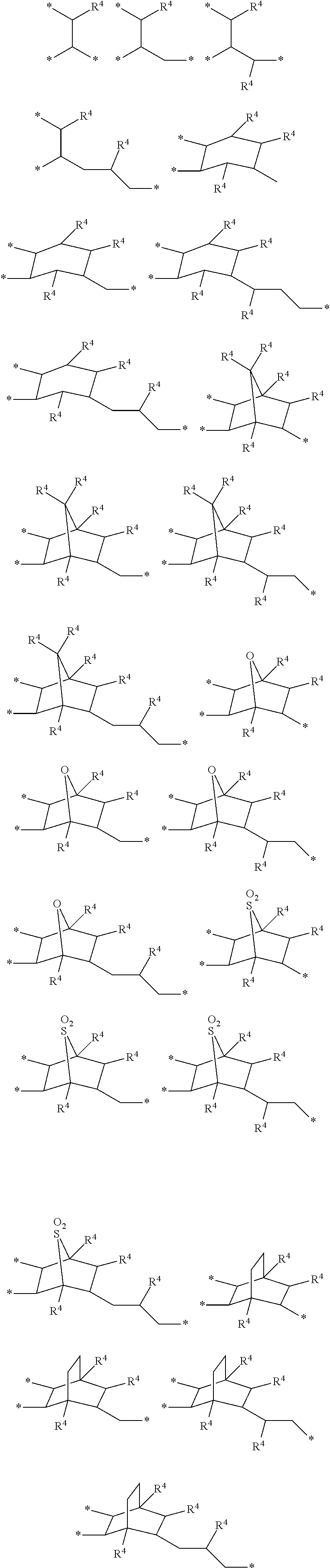

wherein R⁴'s each independently represent a hydrogen atom or a hydrocarbyl group having 1 to 8 carbon atoms. * represents a bond.
4. The siloxane-modified polyester resin according to the item 2 or 3, wherein X is a single bond, a methylene group, a propane-2,2-diyl group, a 1,1,1,3,3,3-hexafluoropropane-2,2-diyl group, or a fluorene-9,9-diyl group.
5. The siloxane-modified polyester resin according to any one of the items 2 to 4, wherein q is an integer of 1 to 30, and Z is a group represented by any one of the following formulas:

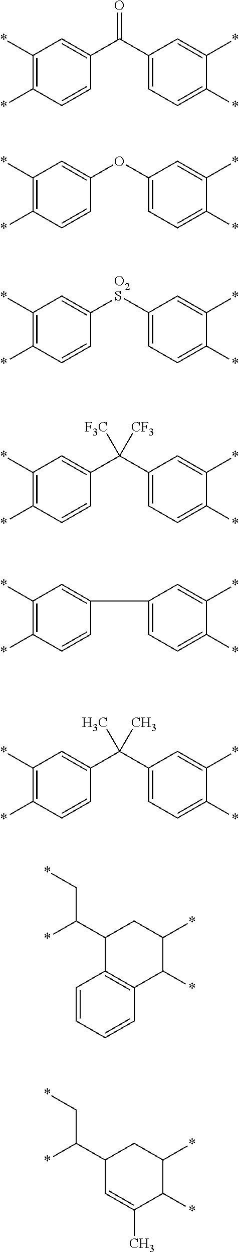

wherein * represents a bond.
6. The siloxane-modified polyester resin according to any one of the items 1 to 5, which has a weight average molecular weight of 3000 to 500,000.
7. A cured product obtained by thermally curing the siloxane-modified polyester resin according to any one of the items 1 to 6.

### ADVANTAGEOUS EFFECTS OF THE INVENTION

By using a siloxane-modified polyester resin of the present invention, a cured product having sufficient flexibility in addition to heat resistance and chemical resistance can be obtained.

### DETAILED DESCRIPTION OF THE INVENTION

### Siloxane-Modified Polyester Resin

A siloxane-modified polyester resin of the present invention is a siloxane-modified polyester resin having a carboxyl group and a (meth)acryloyl group in a side chain thereof.

As such a siloxane-modified polyester resin, a siloxane-modified polyester resin represented by the following formula (1) is preferable.

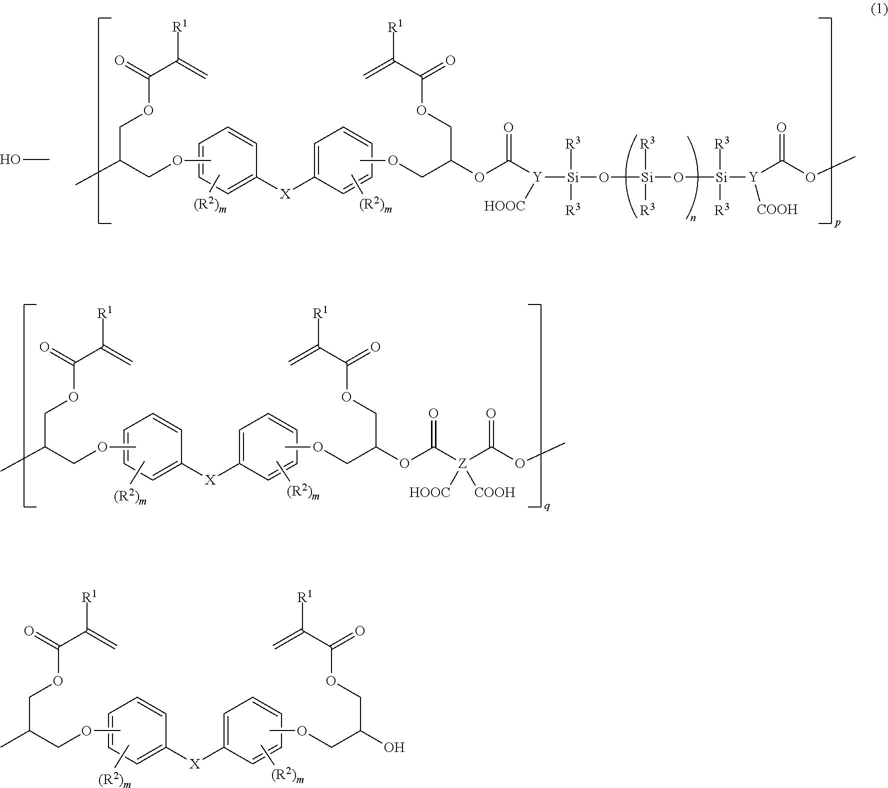

In formula (1), R¹'s each independently represent a hydrogen atom or a methyl group. R²'s each independently represent an alkyl group having 1 to 5 carbon atoms, an aryl group having 6 to 12 carbon atoms, or a halogen atom. R³'s each independently represent a hydrocarbyl group having 1 to 8 carbon atoms. X's each independently represent a single bond or a divalent organic group. Y's each independently represent a trivalent organic group. Z represents a tetravalent organic group. m's are each independently an integer of 0 to 4. n is a number having an average of 0 to 100. p is an integer of 1 to 30. q is an integer of 0 to 30.

Specific examples of the alkyl group having 1 to 5 carbon atoms, represented by R² include a methyl group, an ethyl group, a propyl group, a butyl group, a pentyl group, and structural isomers thereof. Specific examples of the aryl group having 6 to 12 carbon atoms, represented by R² include a phenyl group, a 1-naphthyl group, and a 2-naphthyl group. Specific examples of the halogen atom represented by R² include a fluorine atom, a chlorine atom, a bromine atom, and an iodine atom.

The hydrocarbyl group having 1 to 8 carbon atoms, represented by R³ may be saturated or unsaturated, and may be linear, branched, or cyclic. Specific examples thereof include: an alkyl group such as a methyl group, an ethyl group, a propyl group, a hexyl group, or structural isomers thereof; a cyclic saturated hydrocarbyl group such as a cyclohexyl group; and an aryl group such as a phenyl group. Among these groups, a methyl group and a phenyl group are preferable from a viewpoint of easy availability of raw materials.

The trivalent organic group represented by Y is not particularly limited, but is preferably a saturated hydrocarbon group having 2 to 20 carbon atoms. The saturated hydrocarbon group may be linear, branched, or cyclic, and may contain at least one heteroatom selected from an oxygen atom and a sulfur atom. Such a group is preferably a group represented by any one of the following formulas:

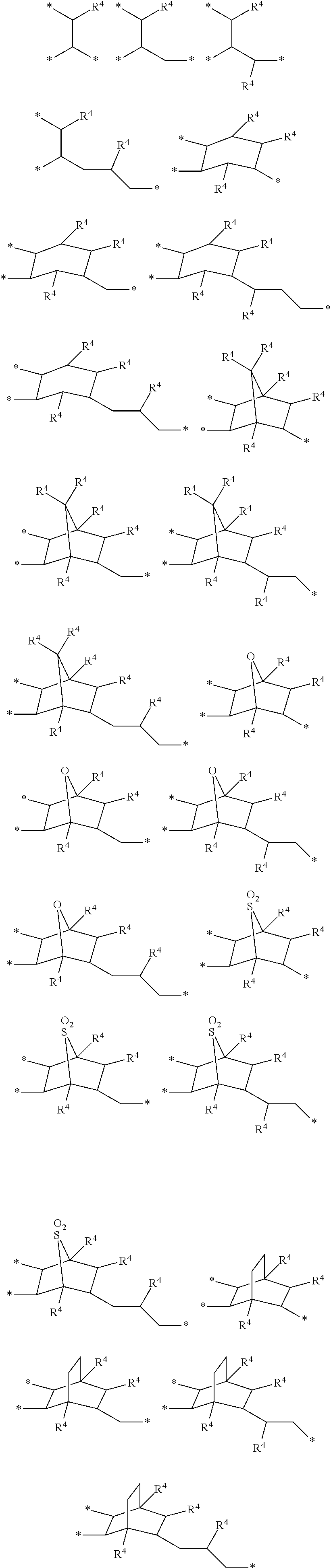

In the formula, R⁴'s each independently represent a hydrogen atom or a hydrocarbyl group having 1 to 8 carbon atoms. * represents a bond. The hydrocarbyl group having 1 to 8 carbon atoms, represented by R⁴ may be saturated or unsaturated, and may be linear, branched, or cyclic. Specific examples thereof include: an alkyl group such as a methyl group, an ethyl group, a propyl group, a hexyl group, or structural isomers thereof; a cyclic saturated hydrocarbyl group such as a cyclohexyl group; and an aryl group such as a phenyl group.

The divalent organic group represented by X is not particularly limited, but is preferably a saturated hydrocarbylene group which has 1 to 20 carbon atoms and may contain a halogen atom or an arylene group which has 6 to 30 carbon atoms and may contain a halogen atom. Specific examples of the halogen atom include a fluorine atom, a chlorine atom, a bromine atom, and an iodine atom. Specific examples of the saturated hydrocarbylene group include a methylene group, an ethane-1,1-diyl group, an ethane-1,2-diyl group, a propane-1,1-diyl group, a propane-1,2-diyl group, a propane-1,3-diyl group, and a propane-2,2-diyl group. Specific examples of the arylene group include a 1,2-phenylene group, a 1,3-phenylene group, a 1,4-phenylene group, a naphthylene group, and a fluorene-9,9-diyl group. X is preferably a single bond, a methylene group, a propane-2,2-diyl group, a 1,1,1,3,3,3-hexafluoropropane-2,2-diyl group, or a fluorene-9,9-diyl group.

p is an integer of 1 to 30, and more preferably an integer of 1 to 20. q is an integer of 0 to 30, and more preferably an integer of 1 to 20. When q is 1 or more, the tetravalent organic group represented by Z is not particularly limited, but is preferably a tetravalent group having an aromatic ring and 6 to 12 carbon atoms or a tetravalent group having an unsaturated alicyclic ring and 6 to 12 carbon atoms. Such a group is particularly preferably a group represented by any one of the following formulas:

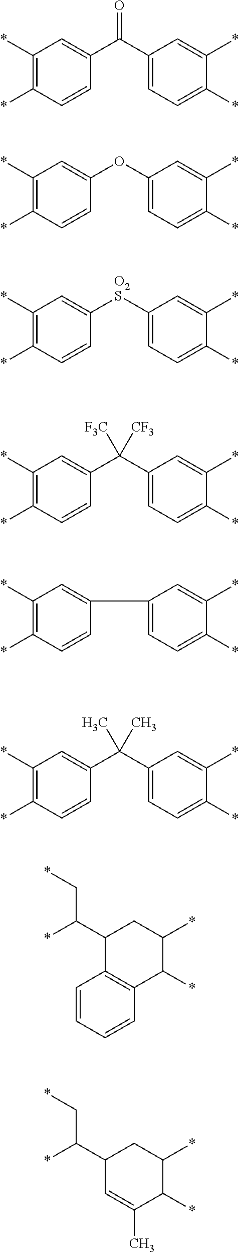

wherein * represents a bond.

The siloxane-modified polyester resin of the present invention preferably has a weight average molecular weight (Mw) of 3000 to 500,000, more preferably 5000 to 200,000. If Mw is in the above range, it is possible to obtain a siloxane-modified polyester resin capable of providing a cured film having heat resistance, solvent resistance, and sufficient flexibility while exhibiting sufficient solubility in a general organic solvent. Note that, in the present invention, Mw is a value measured in terms of polystyrene by gel permeation chromatography (GPC) using tetrahydrofuran as an elution solvent.

### Method for Producing Siloxane-Modified Polyester Resin

A method for producing the siloxane-modified polyester resin is not particularly limited, but examples thereof include a method in which a both terminal carboxylic anhydride-modified siloxane and a diol compound having a (meth)acryloyl group as raw material compounds are caused to react with each other. At this time, an anhydride moiety of the former compound and an alcohol moiety of the latter compound react with each other to form an ester bond to increase a molecular weight. At the same time, a carboxy group is generated in a side chain.

The both terminal carboxylic anhydride-modified siloxane is not particularly limited, but a compound represented by the following formula (2) is preferable.

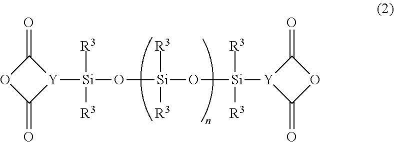

wherein R^{3,} Y and n are as defined above.

The diol compound having a (meth)acryloyl group is not particularly limited, but a compound represented by the following formula (3) is preferable.

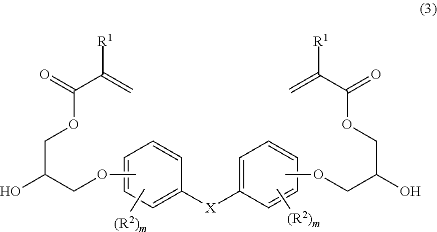

wherein R¹,R², X and m are as defined above.

Furthermore, as the raw material compound, a tetracarboxylic dianhydride other than the both terminal carboxylic anhydride-modified siloxane may be used. The tetracarboxylic dianhydride is preferably represented by the following formula (4):

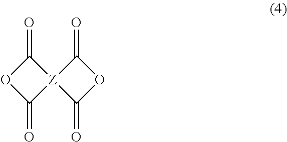

wherein Z is as defined above.

It is not necessary to use a catalyst in the synthesis based on the above-described raw materials, but a catalyst such as an organic amine compound can be used in order to accelerate the reaction. Specific examples of such a catalyst include: a primary amine such as methylamine, ethylamine, butylamine, s-butylamine, t-butylamine, amylamine, octylamine, cyclohexylamine, vinylmethylamine, allylamine, or ethoxymethylamine; secondary amines such as dimethylamine, diethylamine, dipropylamine, diallylamine, dihexylamine, and didodecylamine; tertiary amines such as trimethylamine, triethylamine, and tripropylamine; alkanol amines such as ethanolamine, diethanolamine, and triethanolamine; aliphatic amines having a benzene ring, such as phenylpropylamine, phenylethylamine, methoxybenzylamine, diethylbenzylamine, benzylamine, and dimethylbenzylamine; a morpholine derivative such as morpholine or methylmorpholine; an aniline derivative such as t-butylaniline; aromatic amines such as dimethyltoluidine; a pyridine derivative such as 2-hydroxypyrimidine, 2-hydroxypyridine, 3-hydroxypyridine, or 4-hydroxypyridine; a piperidine derivative such as piperidine, methylpiperidine, or benzylpiperidine; a pyrrolidine derivative such as methylpyrrolidine; a pyrrole derivative such as pyrrole; a quinoline derivative such as 2-hydroquinoline, 3-hydroquinoline, 4-hydroquinoline, 2-methylquinoline, or 4-methyl-8-hydroquinoline; an imidazole derivative such as benzimidazole, methylimidazole, or imidazole; and a quaternary ammonium salt such as tetramethylammonium hydroxide or tetraethylammonium hydroxide. An organotin compound such as dibutyltin laurate or butyltin oxyacetate can also be used as a catalyst for accelerating the reaction.

The amount of the catalyst used is preferably 0.005 to 10 parts by weight, and more preferably 0.01 to 5 parts by weight per 100 parts by weight of a tetracarboxylic dianhydride compound and a diol compound having a (meth)acryloyl group in total as raw materials. The catalysts may be used singly or in combination of two or more types thereof.

In the synthesis based on the above-described raw materials, an organic solvent can be used for the purpose of making the reaction system uniform and facilitating the reaction. Examples of such an organic solvent include: an aromatic hydrocarbon such as benzene, toluene, xylene, ethylbenzene, aromatic petroleum naphtha, tetralin, turpentine oil, or Solvesso® #100 and #150 (manufactured by Exxon Chemical Co., Ltd.); ethers such as dioxane and tetrahydrofuran; esters and ether esters such as methyl acetate, ethyl acetate, n-propyl acetate, isopropyl acetate, n-butyl acetate, isobutyl acetate, secondary butyl acetate, amyl acetate, propylene glycol monomethyl ether, and methoxybutyl acetate; ketones such as acetone, methyl ethyl ketone, diisobutyl ketone, diethyl ketone, methyl propyl ketone, diisopropyl ketone, methyl amylohexanone, isophorone, mesityl oxide, methyl isoamyl ketone, ethyl n-butyl ketone, and ethyl amyl ketone; phosphates such as trimethyl phosphate, tricthyl phosphate, and tributyl phosphate; an aprotic polar solvent such as dimethyl sulfoxide or N,N-dimethylformamide; and a glycol derivative such as triethylene glycol monomethyl ether, diethylene glycol monomethyl ether, diethylene glycol monobutyl ether, diethylene glycol monohexyl ether, propylene glycol monomethyl ether acetate, ethylene glycol monophenyl ether, diethylene glycol monophenyl ether, dipropylene glycol, diethylene glycol-2-ethylhexyl ether, or tetraethylene glycol dimethyl ether. Among these compounds, propylene glycol monomethyl ether acetate is particularly preferable.

The amount of the organic solvent used is not particularly limited, but is preferably such an amount that a concentration of a reaction raw material in each reaction stage is 10 to 80 wt %, and more preferably such an amount that the concentration is 20 to 60 wt %. The organic solvents may be used singly or in combination of two or more types thereof.

A reaction method is not particularly limited, but the target siloxane-modified polyester resin can be obtained by mixing the above-described raw material compounds together with a catalyst in an organic solvent and heating the mixture at 80 to 140° C. for about 3 to 30 hours.

When a both terminal carboxylic anhydride-modified siloxane and a diol compound having a (meth)acryloyl group are used as raw material compounds, it is preferable to use 0.70 to 0.98 mol, more preferably 0.80 to 0.95 mol of the both terminal carboxylic anhydride-modified siloxane per 1 mol of the diol compound having a (meth)acryloyl group. When a both terminal carboxylic anhydride-modified siloxane, a diol compound having a (meth)acryloyl group, and a tetracarboxylic dianhydride other than the both terminal carboxylic anhydride-modified siloxane are used as raw material compounds, preferably 0.70 to 0.98 mol, more preferably 0.80 to 0.95 mol of the both terminal carboxylic anhydride-modified siloxane and the tetracarboxylic dianhydride other than the both terminal carboxylic anhydride-modified siloxane in total are used per 1 mol of the diol compound having a (meth)acryloyl group. Note that, at this time, the both terminal carboxylic anhydride-modified siloxane and the tetracarboxylic dianhydride other than the both terminal carboxylic anhydride-modified siloxane are preferably used so as to satisfy a ratio of both terminal carboxylic anhydride-modified siloxane: tetracarboxylic dianhydride other than the both terminal carboxylic anhydride-modified siloxane=100:0 to 100:1000 (molar ratio).

The siloxane-modified polyester resin of the present invention is formed into a composition containing the siloxane-modified polyester resin and a curing agent, and the composition is applied onto a substrate and then heated, whereby a cured film excellent in heat resistance, chemical resistance, and flexibility can be obtained.

As the curing agent, an isocyanate curing agent can be used. Examples of the isocyanate curing agent include: an aliphatic isocyanate such as methyl isocyanate, tetramethylene diisocyanate, or hexamethylene diisocyanate; an alicyclic isocyanate such as isophorone diisocyanate; an aromatic isocyanate such as toluene diisocyanate, diphenylmethane diisocyanate, or meta-phenylene diisocyanate; and modified products thereof.

The content of the curing agent in the composition is preferably 5 to 50 parts by weight, and more preferably 5 to 45 parts by weight per 100 parts by weight of the siloxane-modified polyester resin of the present invention. The curing agents may be used singly or in combination of two or more types thereof.

The composition may contain a solvent as necessary. Examples of the solvent include: ketones such as cyclohexanone, cyclopentanone, and methyl-2-n-pentyl ketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, propylene glycol mono-tert-butyl ether acetate, and y-butyrolactone. These solvents may be used singly or in combination of two or more types thereof. The content of the solvent in the composition is preferably 50 to 2000 parts by weight, more preferably 50 to 1000 parts by weight, and still more preferably 50 to 100 parts by weight per 100 parts by weight of the polymer of the present invention. The solvents may be used singly or in combination of two or more types thereof.

The composition can be applied to a substrate by a known method. For example, a method such as a dip method, a spin coating method, or a roll coating method can be used. An application amount can be appropriately selected according to a purpose, but is preferably such an amount that a film thickness after volatilization of the solvent is 0.1 to 100 μm.

By heating and curing the applied composition, a film excellent in heat resistance, chemical resistance, and flexibility can be obtained. Heating conditions are appropriately selected according to the types of the siloxane-modified polyester resin of the present invention and a curing agent to be used, but it is usually preferable to perform heating at 50 to 250° C. for about ten minutes to six hours.

### EXAMPLES

Hereinafter, the present invention is described more specifically with reference to Examples and Comparative Examples, but the present invention is not limited to the following Examples. Note that, in the following Examples, Mw was measured by GPC using TSKGEL Super HZM-H (manufactured by Tosoh Corporation) as a GPC column and monodisperse polystyrene as a standard under analysis conditions of a flow rate of 0.6 mL/min, an elution solvent of tetrahydrofuran, and a column temperature of 40° C. FT-IR measurement was performed using a Nicolet™ iS™ 50 FT-IR spectrophotometer manufactured by Thermo Fisher Scientific K.K.

Compounds used in synthesis of the siloxane-modified polyester resin of the present invention are described below.

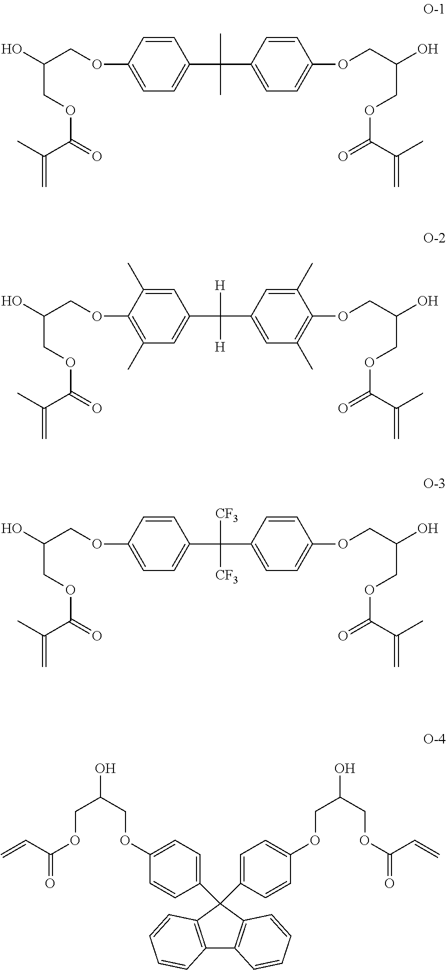

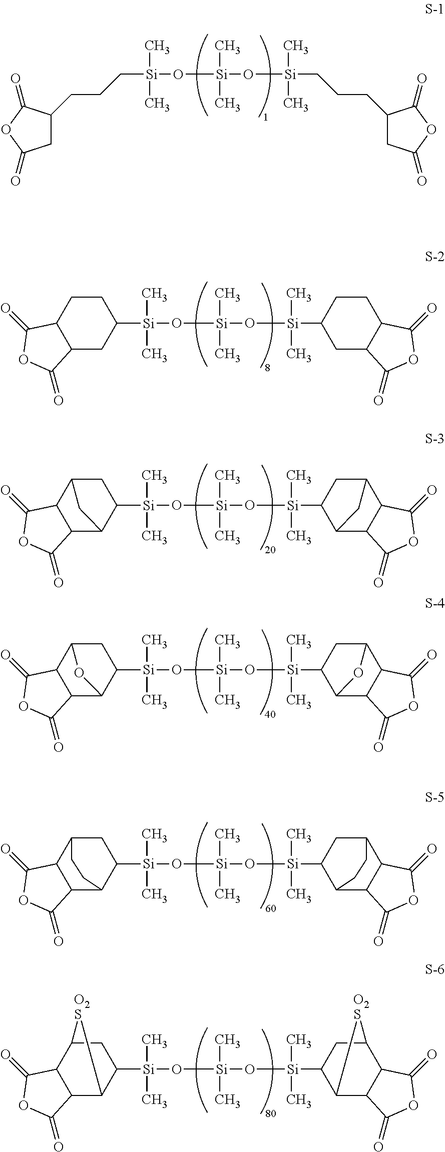

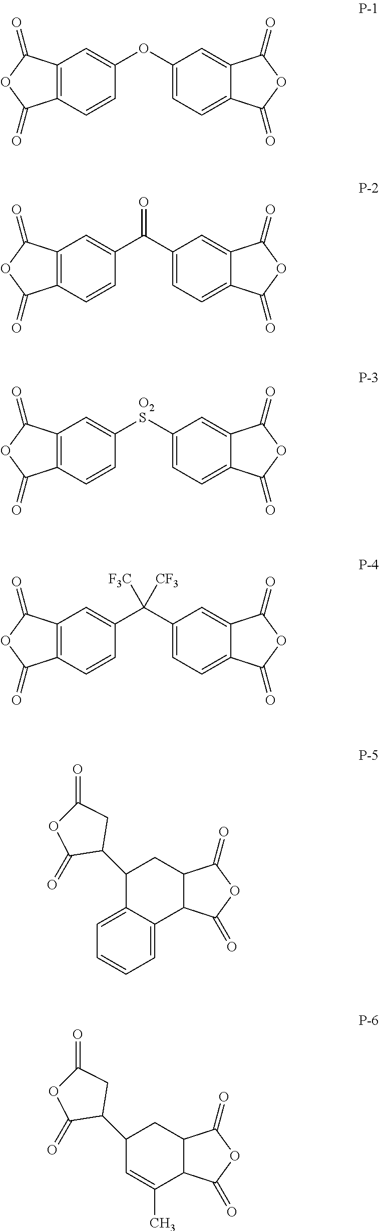 [SMILES: O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(S(=O)(=O)c3ccc4c(c3)C(=O)OC4=O)ccc21 ; O=C1OC(=O)c2cc(C(c3ccc4c(c3)C(=O)OC4=O)(C(F)(F)F)C(F)(F)F)ccc21 ; O=C1CC(C2CC3C(=O)OC(=O)C3c3ccccc32)C(=O)O1 ; CC1=CC(C2CC(=O)OC2=O)CC2C(=O)OC(=O)C12]

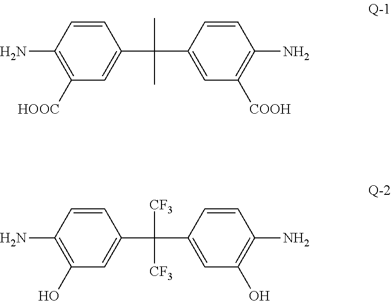 [SMILES: CC(C)(c1ccc(N)c(C(=O)O)c1)c1ccc(N)c(C(=O)O)c1 ; Nc1ccc(C(c2ccc(N)c(O)c2)(C(F)(F)F)C(F)(F)F)cc1O]

### [Example 1] Synthesis of Polymer P-1

To a 500 mL flask equipped with a stirrer, a thermometer, a nitrogen replacing device, and a reflux condenser, 46.18 g (0.094 mol) of a compound (S-1) and 53.82 g (0.105 mol) of a compound (O-1) were added, and then 150 g of propylene glycol monomethyl ether acetate and 1.0 g of tripropylamine were added. The mixture was heated at 110° C. for ten hours, and then cooled to room temperature. Thereafter, the mixture was put in methanol, and an obtained sediment was filtered and then dried to obtain a polymer P-1. By performing FT-IR measurement of the polymer P-1, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-1 was the siloxane-modified polyester resin of the present invention. In addition, when GPC measurement was performed, Mw was 6000.

### [Example 2] Synthesis of Polymer P-2

To a 500 mL flask equipped with a stirrer, a thermometer, a nitrogen replacing device, and a reflux condenser, 63.20 g (0.061 mol) of a compound (S-2) and 36.80 g (0.068 mol) of a compound (O-2) were added, and then 150 g of propylene glycol monomethyl ether acetate was added. The mixture was heated at 130° C. for 30 hours, and then cooled to room temperature. Thereafter, the mixture was put in methanol, and an obtained sediment was filtered and then dried to obtain a polymer P-2. By performing FT-IR measurement of the polymer P-2, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-2 was the siloxane-modified polyester resin of the present invention. In addition, when GPC measurement was performed, Mw was 20,000.

### [Example 3] Synthesis of Polymer P-3

To a 500 mL flask equipped with a stirrer, a thermometer, a nitrogen replacing device, and a reflux condenser, 66.62 g (0.034 mol) of a compound (S-3), 3.03 g (0.010 mol) of a compound (P-1), and 30.35 g (0.049 mol) of a compound (O-3) were added, and then 150 g of propylene glycol monomethyl ether acetate and 1.0 g of tripropylamine were added. The mixture was heated at 110° C. for ten hours, and then cooled to room temperature. Thereafter, the mixture was put in methanol, and an obtained sediment was filtered and then dried to obtain a polymer P-3. By performing FT-IR measurement of the polymer P-3, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-3 was the siloxane-modified polyester resin of the present invention. In addition, when GPC measurement was performed, Mw was 50,000.

### [Example 4] Synthesis of Polymer P-4

To a 500 mL flask equipped with a stirrer, a thermometer, a nitrogen replacing device, and a reflux condenser, 70.00 g (0.020 mol) of a compound (S-4), 5.26 g (0.016 mol) of a compound (P-2), and 24.74 g (0.041 mol) of a compound (O-4) were added, and then 150 g of propylene glycol monomethyl ether acetate was added. The mixture was heated at 130° C. for 30 hours, and then cooled to room temperature. Thereafter, the mixture was put in methanol, and an obtained sediment was filtered and then dried to obtain a polymer P-4. By performing FT-IR measurement of the polymer P-4, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-4 was the siloxane-modified polyester resin of the present invention. In addition, when GPC measurement was performed, Mw was 100,000.

### [Example 5] Synthesis of Polymer P-5

To a 500 mL flask equipped with a stirrer, a thermometer, a nitrogen replacing device, and a reflux condenser, 66.30 g (0.013 mol) of a compound (S-5), 4.81 g (0.013 mol) of a compound (P-3), 5.96 g (0.013 mol) of a compound (P-4), and 22.93 g (0.045 mol) of a compound (O-1) were added, and then 150 g of propylene glycol monomethyl ether acetate and 1.0 g of tripropylamine were added. The mixture was heated at 110° C. for ten hours, and then cooled to room temperature. Thereafter, the mixture was put in methanol, and an obtained sediment was filtered and then dried to obtain a polymer P-5. By performing FT-IR measurement of the polymer P-5, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-5 was the siloxane-modified polyester resin of the present invention. In addition, when GPC measurement was performed, Mw was 150,000.

### [Example 6] Synthesis of Polymer P-6

To a 500 mL flask equipped with a stirrer, a thermometer, a nitrogen replacing device, and a reflux condenser, 45.87 g (0.007 mol) of a compound (S-6), 8.48 g (0.028 mol) of a compound (P-5), 7.46 g (0.028 mol) of a compound (P-6), and 38.18 g (0.071 mol) of a compound (O-2) were added, and then 150 g of propylene glycol monomethyl ether acetate was added. The mixture was heated at 130° C. for 30 hours, and then cooled to room temperature. Thereafter, the mixture was put in methanol, and an obtained sediment was filtered and then dried to obtain a polymer P-6. By performing FT-IR measurement of the polymer P-6, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-6 was the siloxane-modified polyester resin of the present invention. In addition, when GPC measurement was performed, Mw was 200,000.

### [Example 7] Synthesis of Polymer P-7

To a 500 mL flask equipped with a stirrer, a thermometer, a nitrogen replacing device, and a reflux condenser, 25.44 g (0.052 mol) of a compound (S-1), 28.94 g (0.015 mol) of a compound (S-3), 23.07 g (0.037 mol) of a compound (O-3), and 22.55 g (0.037 mol) of a compound (O-4) were added, and then 150 g of propylene glycol monomethyl ether acetate and 1.0 g of tripropylamine were added. The mixture was heated at 110° C. for ten hours, and then cooled to room temperature. Thereafter, the mixture was put in methanol, and an obtained sediment was filtered and then dried to obtain a polymer P-7. By performing FT-IR measurement of the polymer P-7, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-7 was the siloxane-modified polyester resin of the present invention. In addition, when GPC measurement was performed, Mw was 30,000.

### [Example 8] Synthesis of Polymer P-8

To a 500 mL flask equipped with a stirrer, a thermometer, a nitrogen replacing device, and a reflux condenser, 23.20 g (0.022 mol) of a compound (S-2), 25.72 g (0.007 mol) of a compound (S-4), 11.62 g (0.037 mol) of a compound (P-1), 19.20 g (0.037 mol) of a compound (O-1), and 20.26 g (0.037 mol) of a compound (O-2) were added, and then 150 g of propylene glycol monomethyl ether acetate was added. The mixture was heated at 130° C. for 30 hours, and then cooled to room temperature. Thereafter, the mixture was put in methanol, and an obtained sediment was filtered and then dried to obtain a polymer P-8. By performing FT-IR measurement of the polymer P-8, disappearance of a peak (1815, 1760 cm⁻¹) of C═O stretching vibration derived from a carboxylic anhydride, a peak (1710 cm⁻¹) of C═O stretching vibration derived from a carboxyl group, a peak (1650 cm⁻¹) of C═C stretching vibration derived from a (meth)acryloyl group, a peak (1740 cm⁻¹) of C═O stretching vibration derived from an ester bond, and a peak (1010 cm⁻¹) of Si—O—Si antisymmetric stretching vibration derived from siloxane were attributed, and it was confirmed that the polymer P-8 was the siloxane-modified polyester resin of the present invention. In addition, when GPC measurement was performed, Mw was 80,000.

### [Comparative Example 1] Synthesis of Comparative Polymer CP-1 (Siloxane-Modified Polyimide Resin)

To a 500 mL flask equipped with a stirrer, a thermometer, a nitrogen replacing device, and a reflux condenser, 58.32 g (0.119 mol) of a compound (S-1) and 41.68 g (0.133 mol) of a compound (Q-1) were added, and then 150 g of diglyme was added. The mixture was heated at 50° C. for ten hours. Thereafter, a reflux condenser with a moisture receptor was attached to the flask, and then 50 g of toluene was added thereto. The mixture was heated at 150° C. for six hours, and then cooled to room temperature. Thereafter, the mixture was put in methanol, and an obtained sediment was filtered and then dried to obtain a comparative polymer CP-1. When GPC measurement was performed, Mw was 6000.

### [Comparative Example 2] Synthesis of Comparative Polymer CP-2 (Siloxane-Modified Polyimide Resin)

To a 500 mL flask equipped with a stirrer, a thermometer, a nitrogen replacing device, and a reflux condenser, 71.72 g (0.070 mol) of a compound (S-2) and 28.28 g (0.077 mol) of a compound (Q-2) were added, and then 150 g of diglyme was added. The mixture was heated at 50° C. for ten hours. Thereafter, a reflux condenser with a moisture receptor was attached to the flask, and then 50 g of toluene was added thereto. The mixture was heated at 150° C. for six hours, and then cooled to room temperature. Thereafter, the mixture was put in methanol, and an obtained sediment was filtered and then dried to obtain a comparative polymer CP-2. When GPC measurement was performed, Mw was 20,000.

### [Comparative Example 3] Synthesis of Comparative Polymer CP-3 (Siloxane-Modified Polyimide Resin)

To a 500 mL flask equipped with a stirrer, a thermometer, a nitrogen replacing device, and a reflux condenser, 78.35 g (0.040 mol) of a compound (S-3), 3.57 g (0.012 mol) of a compound (P-1), and 18.08 g (0.058 mol) of a compound (Q-1) were added, and then 150 g of diglyme was added. The mixture was heated at 50° C. for ten hours. Thereafter, a reflux condenser with a moisture receptor was attached to the flask, and then 50 g of toluene was added thereto. The mixture was heated at 150° C. for six hours, and then cooled to room temperature. Thereafter, the mixture was put in methanol, and an obtained sediment was filtered and then dried to obtain a comparative polymer CP-3. When GPC measurement was performed, Mw was 50,000.

### [Comparative Example 4] Synthesis of Comparative Polymer CP-4 (Siloxane-Modified Polyimide Resin)

To a 500 mL flask equipped with a stirrer, a thermometer, a nitrogen replacing device, and a reflux condenser, 77.61 g (0.023 mol) of a compound (S-4), 5.83 g (0.018 mol) of a compound (P-2), and 16.56 g (0.045 mol) of a compound (Q-2) were added, and then 150 g of diglyme was added. The mixture was heated at 50° C. for ten hours. Thereafter, a reflux condenser with a moisture receptor was attached to the flask, and then 50 g of toluene was added thereto. The mixture was heated at 150° C. for six hours, and then cooled to room temperature. Thereafter, the mixture was put in methanol, and an obtained sediment was filtered and then dried to obtain a comparative polymer CP-4. When GPC measurement was performed, Mw was 50,000.

### [Comparative Example 5] Synthesis of Comparative Polymer CP-5 (Polyester Resin Not Siloxane-Modified)

To a 500 mL flask equipped with a stirrer, a thermometer, a nitrogen replacing device, and a reflux condenser, 35.26 g (0.114 mol) of a compound (P-1) and 64.74 g (0.126 mol) of a compound (O-1) were added, and then 150 g of propylene glycol monomethyl ether acetate and 1.0 g of tripropylamine were added. The mixture was heated at 110° C. for ten hours, and then cooled to room temperature. Thereafter, the mixture was put in methanol, and an obtained sediment was filtered and then dried to obtain a comparative polymer CP-5. When GPC measurement was performed, Mw was 50,000.

### Heat Resistance Test

To 100 parts by weight of each of the polymers P-1 to P-8 and the comparative polymers CP-1 to CP-4, 30 parts by weight of isophorone diisocyanate as an isocyanate curing agent was added, and 75 parts by weight of cyclopentanone was further added and dissolved until the mixture became uniform. Each solution was applied onto a substrate on which a Cu sputtered layer had been formed by spin coating, prebaked at 120° C. for five minutes, and then thermally cured at 180° C. for one hour to prepare a cured film (thickness: 50 μm) on the copper substrate. This sample was subjected to a heat resistance test at 150° C. for 1000 hours, and then subjected to a cross-cut peeling test (JIS K 5400). Note that the numerical value (A/B) in Table represents the number of fractions (A) peeled off per 100 fractions (B). That is, in a case of 100/100, a film was not peeled off at all, and in a case of 0/100, the entire film was peeled off. Results thereof are presented in Table 1.

### Evaluation of Flexibility

The Cu sputtered substrate with the cured film before the heat resistance test was immersed in an aqueous solution having a phosphoric acid concentration of 20% and a hydrogen peroxide concentration of 10% for one hour to etch the Cu sputtered layer, thereby obtaining a short film of each cured film. The obtained cured film was wound around a plastic cylinder having an outer diameter of 10 mm and allowed to stand for 10 seconds. Thereafter, the film was returned to the original state, and it was confirmed whether or not there was abnormality on the film. When cracking or the like occurred, it was evaluated as “x”, and when there was no change, it was evaluated as “◯”. Results thereof are presented in Table 1.

TABLE 1

| | | Example | | | | | | | | Comparative Example | | | | |
|---|---|---|---|---|---|---|---|---|---|---|---|---|---|---|
| | | 1 | 2 | 3 | 4 | 5 | 6 | 7 | 8 | 1 | 2 | 3 | 4 | 5 |
| Polymer | P-1 | 100 | — | — | — | — | — | — | — | — | — | — | — | — |
| | P-2 | — | 100 | — | — | — | — | — | — | — | — | — | — | — |
| | P-3 | — | — | 100 | — | — | — | — | — | — | — | — | — | — |
| | P-4 | — | — | — | 100 | — | — | — | — | — | — | — | — | — |
| | P-5 | — | — | — | — | 100 | — | — | — | — | — | — | — | — |
| | P-6 | — | — | — | — | — | 100 | — | — | — | — | — | — | — |
| | P-7 | — | — | — | — | — | — | 100 | — | — | — | — | — | — |
| | P-8 | — | — | — | — | — | — | — | 100 | — | — | — | — | — |
| Comparative | CP-1 | — | — | — | — | — | — | — | — | 100 | — | — | — | — |
| polymer | CP-2 | — | — | — | — | — | — | — | — | — | 100 | | — | — |
| | CP-3 | — | — | — | — | — | — | — | — | — | — | 100 | — | — |
| | CP-4 | — | — | — | — | — | — | — | — | — | — | — | 100 | — |
| | CP-5 | — | — | — | — | — | — | — | — | — | — | — | — | 100 |

| | | | | | | | | | | | | | |
|---|---|---|---|---|---|---|---|---|---|---|---|---|---|
| Isophorone diisocyanate | 30 | 30 | 30 | 30 | 30 | 30 | 30 | 30 | 30 | 30 | 30 | 30 | 30 |
| Cyclopentanone | 75 | 75 | 75 | 75 | 75 | 75 | 75 | 75 | 75 | 75 | 75 | 75 | 75 |
| Heat resistance | 100/100 | 100/100 | 100/100 | 100/100 | 100/100 | 100/100 | 100/100 | 100/100 | 0/100 | 0/100 | 0/100 | 0/100 | 0/100 |
| Flexibility | ∘ | ∘ | ∘ | ∘ | ∘ | ∘ | ∘ | ∘ | x | x | x | x | x |

From the above results, according to the present invention, it is possible to synthesize and provide a siloxane-modified polyester resin having a carboxyl group and a (meth)acryloyl group in a side chain thereof like the polymers P-1 to P-8. In addition, a cured film thereof was excellent in heat resistance and flexibility.

Japanese Patent Application No. 2024-060307 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A siloxane-modified polyester resin having a carboxyl group and a (meth)acryloyl group in a side chain thereof.

2. The siloxane-modified polyester resin according to claim 1, which has the following formula (1): 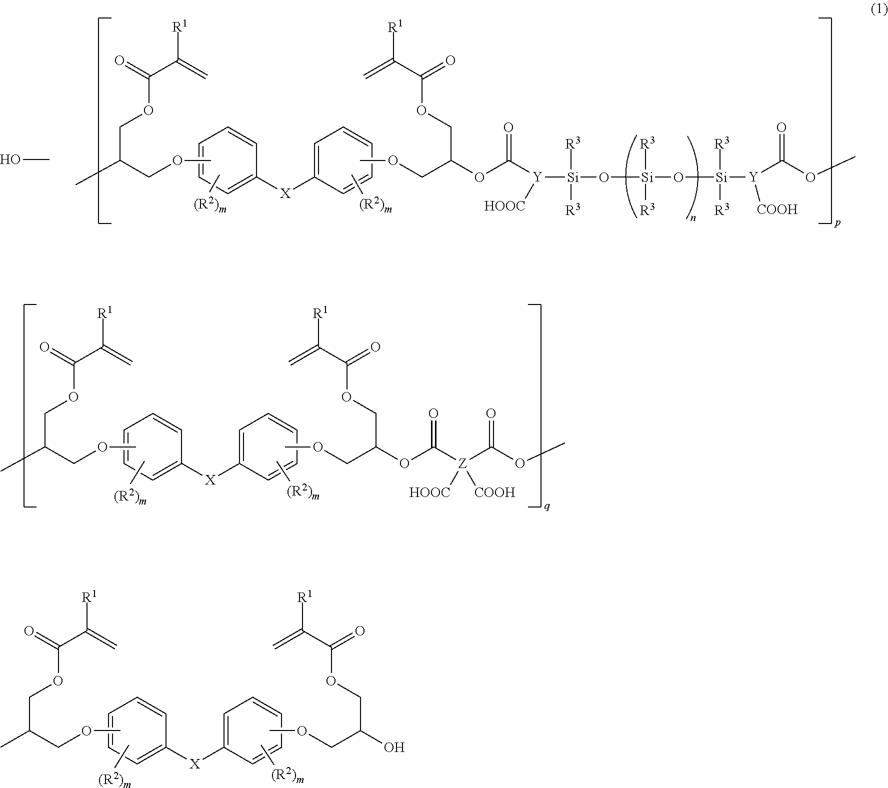
wherein R¹'s each independently represent a hydrogen atom or a methyl group,
R²'s each independently represent an alkyl group having 1 to 5 carbon atoms, an aryl group having 6 to 12 carbon atoms, or a halogen atom,
R³'s each independently represent a hydrocarbyl having 1 to 8 carbon atoms,
X's each independently represent a single bond or a divalent organic group,
Y's each independently represent a trivalent organic group,
Z represents a tetravalent organic group,
m's are each independently an integer of 0 to 4, n is a number having an average of 0 to 100, p is an integer of 1 to 30, and q is an integer of 0 to 30.

3. The siloxane-modified polyester resin according to claim 2, wherein Y is a group having any one of the following formulas: 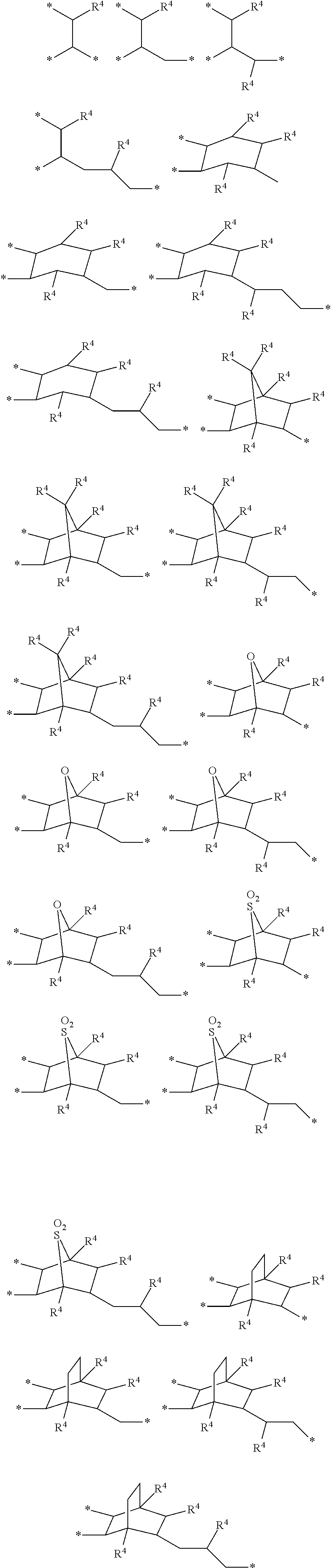
wherein R⁴'s each independently represent a hydrogen atom or a hydrocarbyl group having 1 to 8 carbon atoms. * represents a bond.

4. The siloxane-modified polyester resin according to claim 2, wherein X is a single bond, a methylene group, a propane-2,2-diyl group, a 1,1,1,3,3,3-hexafluoropropane-2,2-diyl group, or a fluorene-9,9-diyl group.

5. The siloxane-modified polyester resin according to claim 2, wherein q is an integer of 1 to 30, and Z is a group having any one of the following formulas: 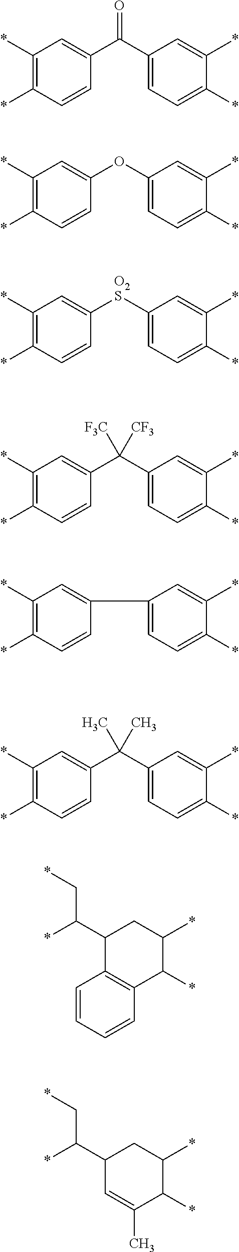
wherein * represents a bond.

6. The siloxane-modified polyester resin according to claim 1, which has a weight average molecular weight of 3000 to 500,000.

7. A cured product obtained by thermally curing the siloxane-modified polyester resin according to claim 1.
